(19) United States
(12) Patent Application Publication
(10) Pub. No.: US 2007/0249236 A1
(43) Pub. Date: Oct. 25, 2007

(54) System for ensuring electrical continuity in connection between pre-wired electrical harnesses and conduits

(76) Inventor: Randy Petak, Pico Rivera, CA (US)

Correspondence Address: CHRISTIE, PARKER & HALE, LLP, PO BOX 7068, PASADENA, CA, 91109-7068, US

(21) Appl. No.: 11/408,817

(22) Filed: Apr. 20, 2006

(51) Int. Cl. H01R 13/64

(52) U.S. Cl. 439/680

(57) ABSTRACT

A system for ensuring electrical continuity in connections between a pre-wired conduit and a pre-wired harness. The pre-wired conduit has at least two conduit wires electrically connected to a plug connector having a plug body with a plurality of prongs greater in number than two, with each prong having a tunnel. Metallic contacts connected to the conduit wires are located in the tunnels of less than the total number of prongs. The pre-wired harness has a plurality of harness wires equal to or greater than the number of conduit wires, and the harness wires connect to plugs located in recesses in the socket body of a socket connector. The recesses number the same as the prongs and the recesses have a number of jacks equal to or greater than the number of conduit wires. Blocking caps are inserted into the tunnels of prongs that are unoccupied by metallic contacts to prevent connection with the pre-wired harness for mis-matched pre-wired conduit and pre-wired harnesses.

### SUMMARY OF THE INVENTION

The invention relates to the field of pre-wired electrical harness and conduits, and more particularly to a system for helping to prevent mismatch mistakes from occurring when connecting electrical harnesses and electrical conduits together, to thereby ensure that electrical continuity is maintained.

Prewired electrical systems use pre-fabricated wiring components, connectors, devices and device boxes to save the installer time during the installation of electrical systems in buildings. For example, projects such as hotels, hospitals, apartment buildings, schools, and other commercial structure, which require that wiring be placed inside metal conduits, take more time to install than typical residential wiring, where non-metallic sheathed plastic insulated wire (Romex) cable is often used.

The pre-fabricated wiring components are generally provided with easily connectable connectors located at one or more ends of the wiring components. For example, these connectors can comprise complementary, interlocking plastic and metal plug and socket connectors that are electrically connected to wires, e.g., by having wires crimped to complementary contacts located therein. When the plug and socket connectors are joined together, they will provide for electrical continuity between the pre-wired conduits and the pre-wired harnesses attached together. As used herein, the term “pre-wired conduits” encompasses wires located in an outer conduit, whether aluminum, steel, plastic, etc, MC cable (metal clad cable), AC cable (armor clad cable), and other sheathing around wires (typically insulated stranded wires or solid wires). The pre-wired conduits will have wires contained in a flexible metal conduit sleeve with a plug or socket connector located at one or both ends and conduit box connectors designed to engage with conduit boxes. These pre-wired conduits are manufactured according to length, number of wires and their gauge requirements: e.g., 12 foot lengths of aluminum conduit, with three 12 gauge insulated wires (i.e., a hot wire-black, a neutral wire-white and a ground wire-green); and 12 foot lengths of aluminum conduit, with four 12 gauge insulated wires (i.e., two hot wires-black and red wires, a neutral wire-white and a ground wire-green), etc. The pre-wired harnesses can likewise be assembled according to its use and requirements. For example, for terminating single electrical outlet use, the pre-wired harnesses will have a single, complementary female connector connected to three 12 gauge insulated wires (i.e., a hot wire-black, a neutral wire-white and a ground wire-green.) If the electrical outlet is to be connected to at least two other conduits, then the pre-wired harnesses will have two complementary female connectors with wires connecting to each other and with wire pigtails for connection with the electrical outlet. In use, the electrician will select a pre-wired conduit, prepare outlet boxes by removing the required number of knock-outs, and engage the conduit box connector to the conduit box, thereby placing the wiring with the terminating male connector inside of the conduit box. Thereafter, the electrician can connect the pre-wired harness (which can be connected in advance to the electrical device, such as an outlet or switch), by engaging the pre-wired harness' female connector to the pre-wired conduit's male connector. Likewise, the pre-wired harness can be engaged with the pre-wired conduit before connecting the wires of the pre-wired harness to the electrical device.

One potential problem with pre-wired systems is that electricians sometimes make installation errors, such as installing a pre-wired conduit having three wires in the wall and thereafter connecting it to a wiring harness having four wire connections. Since the connectors at the ends of pre-wired conduits and pre-wired harnesses typically have the same format, regardless of whether they are designed for three, four or five wires, nothing prevents this from occurring, and the electrician may believe everything is in order at the time of installation. Thereafter, wall covering material, such as drywall, cement board, etc. will typically be installed over the studs and rafters. Upon completion of the installation of the wall covering, the electrician will return to the job site and attach electrical devices, such as electrical outlets and switches, to the pre-wired conduit. If it is later discovered that the device or devices do not function properly (e.g., a duplex outlet that is supposed to have one permanently on outlet and one outlet that is to be controlled by a switch, such as to control a floor lamp, but has both outlets permanently energized), this may require the removal of the conduit from the wall. This can be a costly mistake that can require removal and repair of the wallboard, tile, wallcovering, paint, etc. Accordingly, there remains a need for a system to help prevent errors of this type.

### BRIEF DESCRIPTION OF THE DRAWINGS

FIG. 1 is a top view of an exemplary pre-wired electrical conduit.

FIG. 2 is a detail showing one end of the exemplary pre-wired electrical conduit of FIG. 1 engaged with a wall of an electrical outlet box.

FIG. 3 is a top view of an exemplary pre-wired electrical harness.

FIG. 4 is a front view of the plug connectors of the exemplary pre-wired electrical conduit of FIG. 1.

FIG. 5 is a partially exposed side view of the plug connectors of the exemplary pre-wired electrical conduit of FIG. 1.

FIG. 6 is an isometric view showing a three wire plug connectors of FIGS. 4 and 5 with one blocking cap inserted into a first empty prong and another blocking cap prior to being inserted into a second empty prong of the plug connector.

FIG. 7 is a rear isometric view showing a three wire socket connector of the exemplary pre-wired electrical harness of FIG. 3.

FIG. 8 is a front view showing the socket connector of FIG. 7.

FIG. 9 is an isometric, partially exposed view showing a socket connector like that of FIG. 7, but having five wires, being aligned to attempt to engage with the three wire plug connector of FIG. 6, but with blocking caps in empty prongs.

FIG. 10 is another isometric, partially exposed view similar to that of FIG. 9, but with the socket connector and plug connector not being able to be engaged.

FIG. 11 is a detail showing one end of the exemplary pre-wired electrical conduit of FIG. 1 engaged with a wall of an electrical outlet box and connected to the exemplary pre-wired electrical harness of FIG. 3.

### DETAILED DESCRIPTION OF THE INVENTION

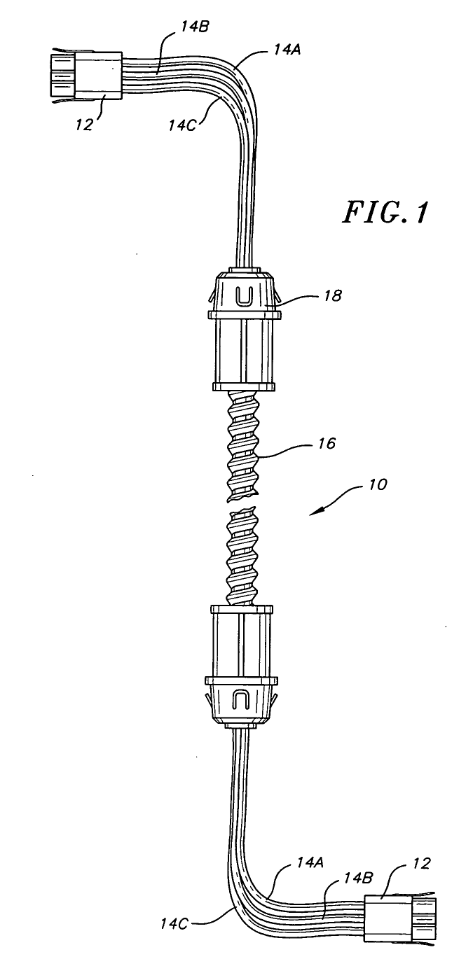

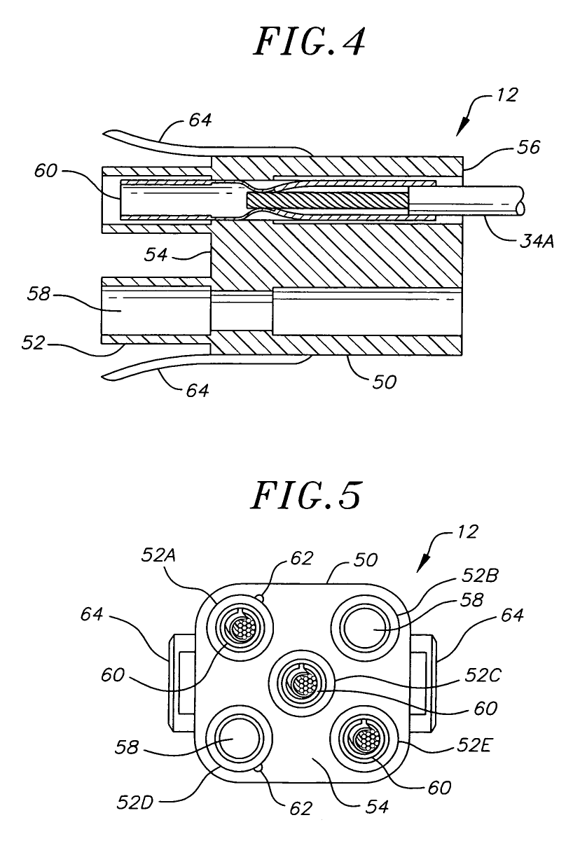

Referring now to FIG. 1, there is shown a top view showing an exemplary pre-wired conduit 10. It has two plug connectors 12 connected to terminal ends of wires 14A, 14B and 14C that pass through a flexible conduit sleeve 16. Located at the ends of flexible conduit sleeve 16 are conduit box connectors 18 for fixing the flexible conduit to conduit boxes (not shown.) The features and construction of the plug connectors 12 will be described below with respect to FIGS. 4 and 5.

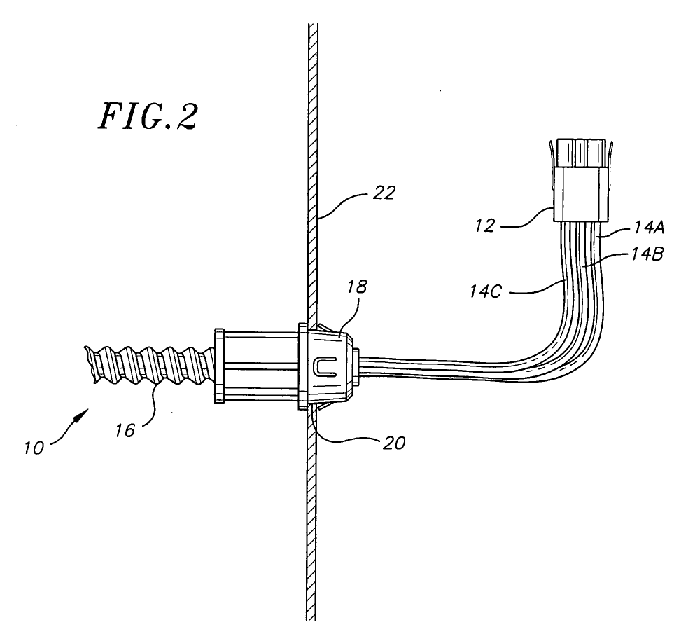

FIG. 2 shows one of the plug connectors 12 and wires 14A, 14B and 14C of one end of the pre-wired conduit 10 inserted through a hole 20 in the wall 22 of a conduit box with the conduit box connector 18 on the conduit sleeve 16 engaged therewith. The plug connectors 12 and wires 14A, 14B and 14C will be located inside the conduit box.

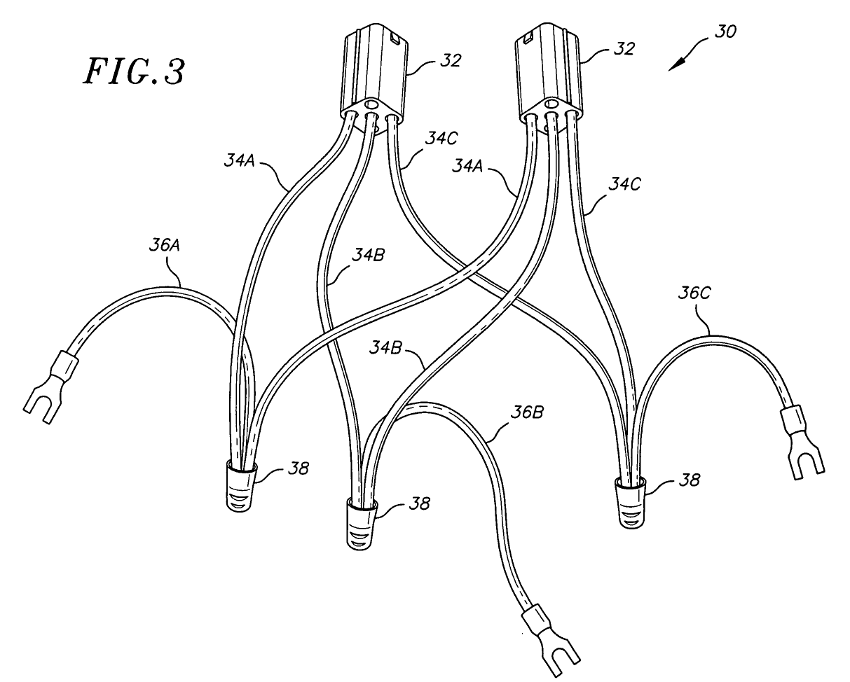

FIG. 3 shows a front view showing an exemplary pre-wired harness 30 having two socket connectors 32 for use in connecting to a mid-circuit electrical outlet. Its pair of socket connectors 32 are connected to wires 34A, 34B and 34C (e.g., hot wire 34A, neutral wire 34B and ground wire 34C) that are connected to each other and to corresponding pigtail leads 36A, 36B and 36C (e.g., by crimps 38) and are used for connecting the pre-wired harness to an electrical device (not shown.)

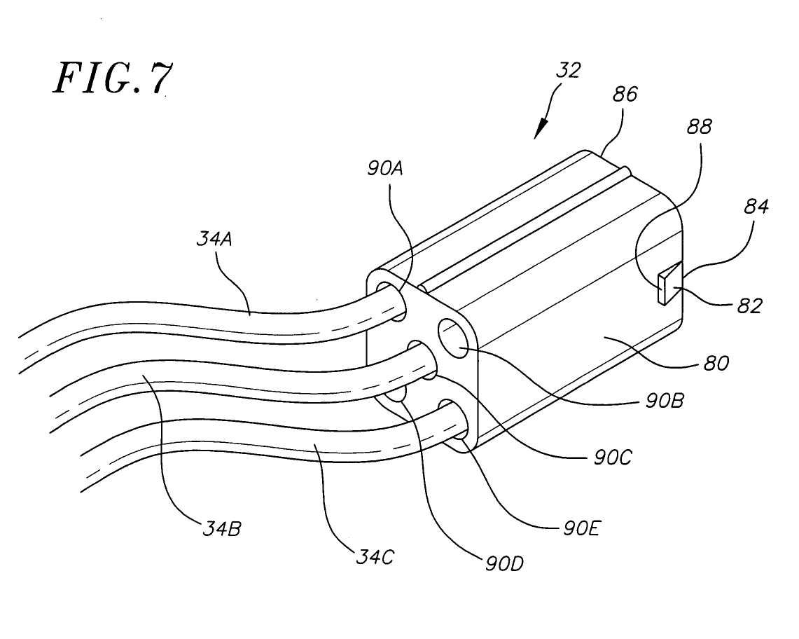

FIGS. 4 and 5 show a partially cut-away side view, and a front view, respectively, of the exemplary plug connector 12. The exemplary plug connector 12 has an insulated body 50 (such as made of plastic material) with a plurality of first engagement members or prongs 52 (52A-E) extending from a mating end 54 that is opposite from a wire entry end 56. The prongs 52 have channels 58 formed therethrough, which are adapted to retain electrical contacts 60 that are connected to wires 34A (with wires 34B and 34C not shown). Placed inside a desired number of the channels 58 are the electrical contacts 60, such as metal sleeves (e.g., brass) that are open at the end located in the prongs 52 and are crimped around the wires (e.g., 34A, 34B and 34B) inserted through the wire entry ends 56. As an alignment guide, ridges 62 can be formed on one or more of the prongs 52A and 52D. These ridges 62 will prevent the plug connector 12 from being inserted into the complementary socket connector 32 unless the prongs with wires are properly aligned with the socket connector 32, as will be discussed below. While two ridges 62 are shown, a different number of ridges can be used, or the shapes and/or sizes of the prongs and their complementary recesses in the socket connector 32 can be made different, as desired. Locking flaps 64 are formed on the insulated body portion 50. The locking flaps 64 are designed to lockably hold the plug connector 12 in electrical contact with the socket connector 32 by snapping onto protrusions 82 formed on the socket connector (as shown in FIG. 7), and prevent the plug and socket connectors from inadvertently being pulled apart from each other and thereby losing electrical contact.

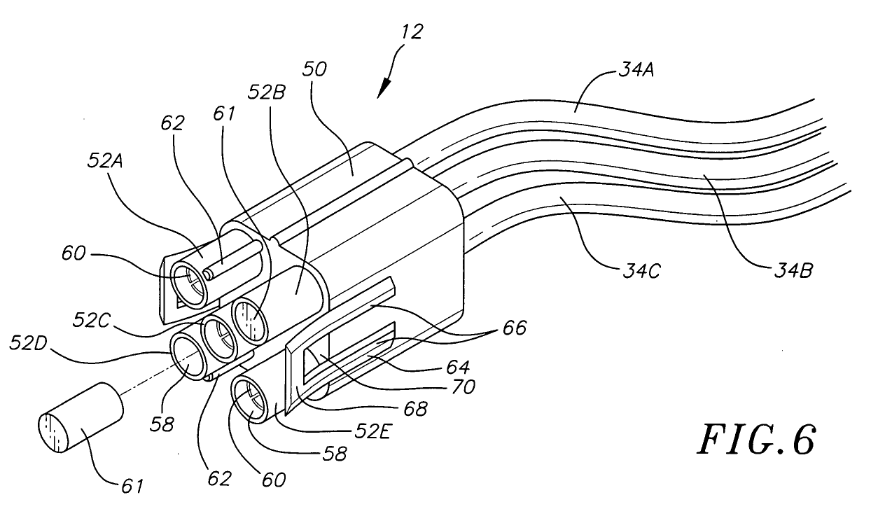

FIG. 6, shows an exemplary three wire plug connector 12 with one of its unused prongs 52B (not having an electrical contact placed therein) with a blocking cap 61 placed inside of the channel, and with another blocking cap 61 prior to being placed in the channel 58 of the prong 52D. As shown, the locking flaps 64 can comprise two legs 66, a bar 68 bridging the two legs 66 and a recess 70 defined between the legs 66. Locking flaps 64 can be located on opposite sides of the insulated body portion 50. The function of these blocking caps 61 is discussed below. The blocking cap 61 can, for example, comprise a cylindrical section of plastic or other material that frictionally fits within the channel 58 and thereby prevents a prong from being inserted therein.

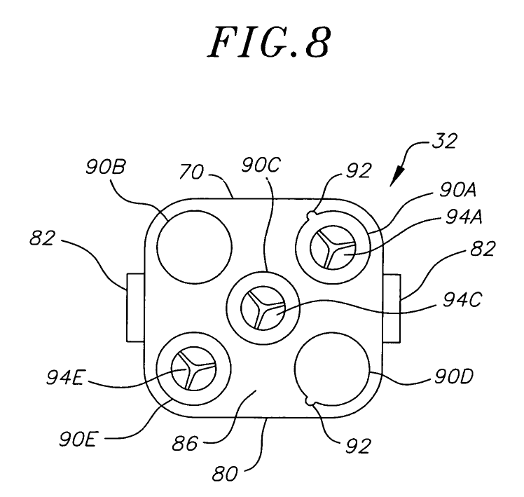

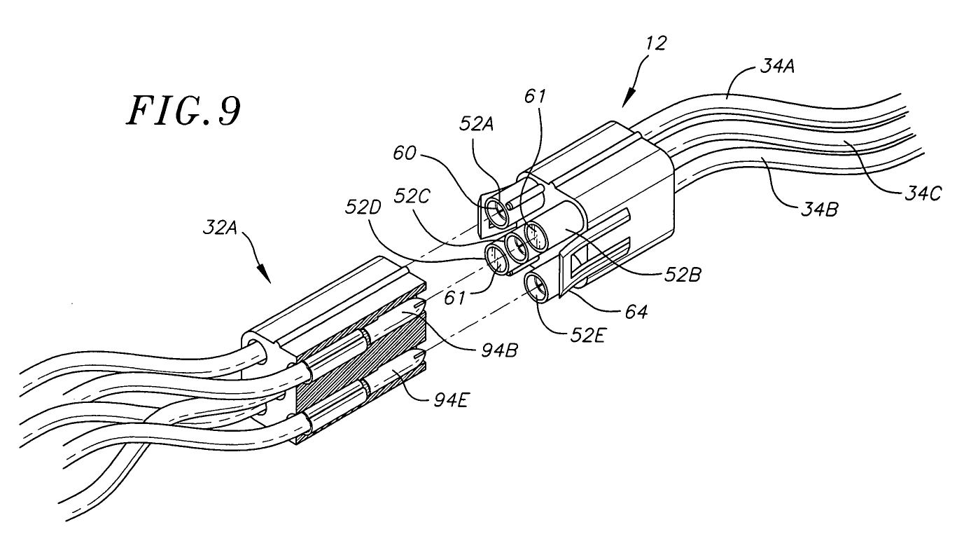

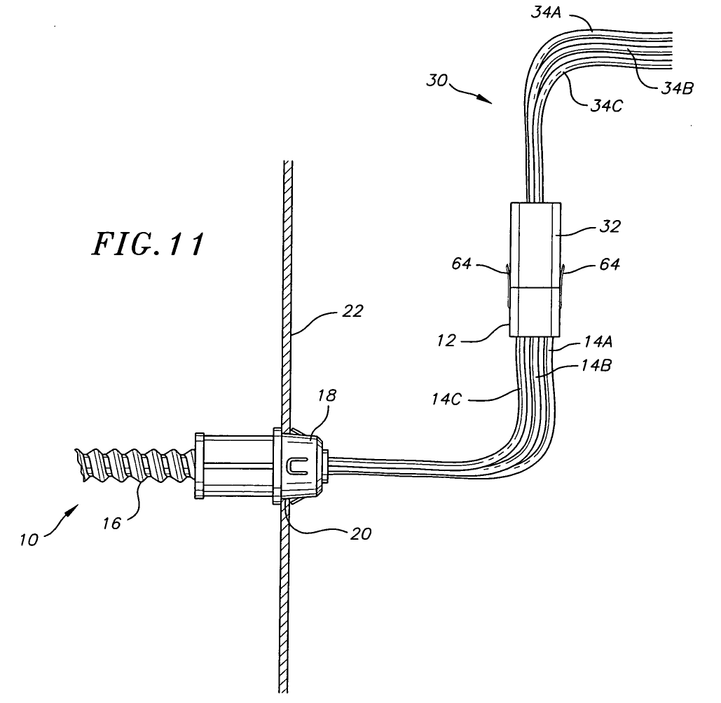

Turning now to FIGS. 7 and 8, there are shown, respectively, a rear isometric view and a front view of the socket connector 32, showing its body portion 80 and protrusions 82. The protrusions 82 can be wedge-shaped and extend from a lower end 84 at or near a front face 86 of the body portion 80 to a higher end with a seat 88 that will seat the bar 68 of the locking flap 64 of the prong connector 12 when they are engaged together, as shown in FIG. 11. Formed through the body portion 80 are a plurality of second engagement portions that are complementary to the first engagement portion, e.g., tunnels 90A-E. The tunnels 90A-E have shape(s) that accommodate the complementary plugs 52A-E that are to be inserted therein. For example, the tunnels 90A-E can have a generally cylindrical shape, with each of tunnels 90A and 90D having an additional notch 92 to accommodate the ridges 62 on prongs 52A and 52D of the plug connector 12. Positioned in the tunnels are metallic jacks 94A, 94C and 94E which are electrically connected to wires 34A, 34B and 34C, respectively.

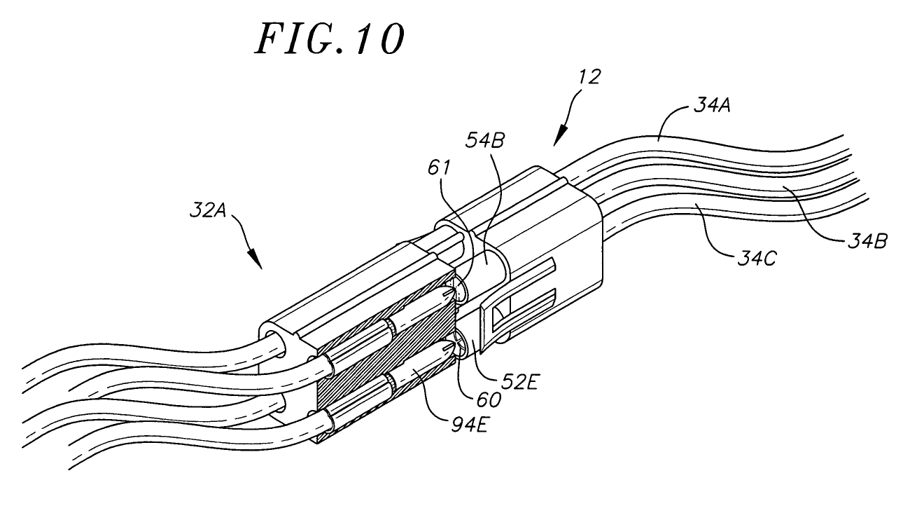

Turning now to FIG. 9, there is shown a rear isometric view of partially cutaway view of another, slightly different socket connector 32A, and the plug connector 12. The slightly different socket connector 32A has five wires and five jacks and is used for device(s) that requires five wires, such as wiring to an outlet box having a standard on-off switch (which requires two wires plus a ground wire) and a standard duplex outlet (which requires two wires plus a ground wire, which ground wire can be shared with the ground wire for the switch.) The plug connector 12 has its prongs 52A, 52C and 52E open and available to receive complementary jacks 94A, 94C and 94E, but the entrances to prongs 52B and 52D are blocked off by blocking caps 61. Therefore, an attempt to engage socket connector 32A with plug connector 12 will result in jacks 94B and 94D (not shown) being prevented from entering the channels 58 in prongs 52B and 52D, as best shown in FIGS. 9 and 10. Absent the presence of the blocking caps 61 inserted into channels not having metal contacts 60, it would be possible for an electrician to mate a pre-wired harness having four or five wires to a pre-wired conduit having just three wires. If this occurs, and the wall covering is applied over studs and/or ceiling joists, the electrical device(s) may not function at all or as intended, and this may require removal of the wallcovering and replacement of the electrical conduit. Accordingly, the feature of the blocking cap 61 will prevent electricians from being able to connect a pre-wired harness, having a greater number of wires, to a pre-wired conduit having a lesser number of wires. In the opposite situation, where a pre-wired conduit is inadvertently used having a greater number of wires than that of the pre-wired harness, this would not prevent an electrician from connecting the pre-wired harness to the pre-wired conduit. However, if the electrician later discovers (e.g., after the wallcovering is applied) that the device(s) do not function properly, this would not require that the pre-wired conduit be removed from the wall (since more than a sufficient number of wires are already in place between the conduit boxes) but possibly only a modification of the pre-wired harness or exchange to another pre-wired harness will be needed. Thus, in this way, any need to remove the pre-wired conduit from a wall can be avoided.

FIG. 11 is similar to the view 2, but shows a three wire socket connector 32 with wires 34A-C connected to a three wire plug connector 12, with the plug connector 18 engaged with a wall 22 of an outlet box. As can be appreciated, if a pre-wired harness 30 having a lesser number of wires is inadvertently connected to the pre-wired conduit having a greater number of wires, the electrician can, by working from inside of the outlet box, make any necessary changes without the need to remove the pre-wired conduit.

While the pre-wired conduits has been described as having plug connectors and the pre-wired harness has been described as having socket connectors, the placement of the plug connectors and socket connectors can be reversed during the manufacture of the pre-wired conduits and harnesses. It is also possible for the plug connector to include both prong(s) and recess(s) and for the socket connector in have both recess(es) and prong(s), which are adapted to engage each other.

Furthermore, the placement of the electrical contacts 60 inside of the channels 58 of the prongs 52 of the plug connectors 12 and the placement of the metallic jacks 94 in the tunnels 90 of the socket connectors 32 provide an extra measure of safety since if the plug connector and socket connectors should become separated when the circuit is energized, then neither the electrical contacts 60 nor the metallic jacks 94 will be able to short out with anything or anyone.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention.

1. A system for ensuring electrical continuity in connections between a pre-wired conduit and a pre-wired harness, the pre-wired conduit having at least two conduit wires which are in electrical connection with a plug connector, the plug connector having a plug body with a plurality of prongs greater in number than two, each prong having a tunnel formed therethrough, wherein metallic contacts connected to the at least two conduit wires are located in the tunnels of less than the total number of prongs, the pre-wired harness having a plurality of harness wires equal to or greater than the number of conduit wires in the pre-wired conduit, the socket connector having a socket body with the same number of recesses formed therein as there are prongs on the plug connector, and having a number of jacks equal to or greater than the number of conduit wires and electrically connected to the at least two harness wires, each jack being located in a recess in a body of the socket connector, wherein the improvement comprises:
a blocking device that is adapted to be inserted into a tunnel that is not occupied by a metallic contact to prevent the prongs of the plug connector, having a lesser number of conduit wires than the number of harness wires connected to the socket connector, from being inserted into the recesses of the socket connector, wherein except for the plug, the prongs would be insertable into the recesses of the harness connector.

2. The system of claim 1, wherein the blocking device comprises an insert that fits within the tunnel of a prong that is unoccupied by a metal contact connected to a conduit wire.

3. The system of claim 1, wherein the metallic contact comprises a sleeve sized to frictionally engage a prong of the plug connector.

4. A system for ensuring electrical continuity in connections between a pre-wired conduit and a pre-wired harness, the pre-wired conduit having at least two conduit wires which are in electrical connection with a plug connector having a plurality of prongs greater in number than two, each having a tunnel formed therein, with at least some of the tunnels having electrical contacts located therein, and wherein electrical contacts connected to the at least two conduit wires are present in less than the total number of protrusions, the pre-wired harness having a plurality of harness wires equal to or greater in number than the number of conduit wires, the socket connector having a socket body with the same number of recesses as there are protrusions in the plug connector, and having a number of complementary electrical contacts located in the recesses equal to or greater than the number of conduit wires and electrically connected to the at least two harness wires, each complementary electrical contact being located in a recess in the body of the socket connector, wherein the improvement comprises:
a plug that is adapted to be inserted into a tunnel that is not occupied by a metallic contact to prevent the electrical contacts of the prongs from making electrical contacts with the complementary electrical contacts of the recesses when the number of conduit wires is less than the number of harness wires, wherein except for the plug, the prongs would be insertable into the recesses of the harness connector.

5. (canceled)

6. (canceled)
